(19) United States
(12) Patent Application Publication
(10) Pub. No.: US 2017/0278411 A1
(43) Pub. Date: Sep. 28, 2017

(54) MONITORING SYSTEM FOR AIRCRAFT GUIDING PROCESS AND A MONITORING METHOD THEREOF

(71) Applicant: UNIBASE INFORMATION CORP., NEW TAIPEI CITY (TW)

(72) Inventor: CHENG-HSIANG LIN, NEW TAIPEI CITY (TW)

(21) Appl. No.: 15/464,511

(22) Filed: Mar. 21, 2017

(30) Foreign Application Priority Data
Mar. 23, 2016 (TW) 105108985

(51) Int. Cl. G08G 5/06; H04N 5/77; H04N 5/262; H04N 7/18; H04N 5/445

(52) U.S. Cl. CPC G08G 5/065; H04N 7/181; H04N 5/44591; H04N 5/2624; H04N 5/77; H04N 7/188

(57) ABSTRACT

A monitoring system for an aircraft guiding process is used to monitor a docking process of an aircraft guided by a guiding information display of a VDGS (Visual Docking Guidance System) along a J-line at an apron, and includes an image capturing module, an image integrating unit, a monitoring display and a video recorder. The image capturing module has a first camera for filming a docking process of an aircraft to obtain a docking video, and a second camera for filming the guiding information display to obtain a guiding information video. The image integrating unit integrates the docking video and the guiding information video into an integrated video in a synchronously-displayed and adjoining manner. The monitoring display receives and displays the integrated video. The video recorder records the integrated video. Accordingly, the present disclosure also provides a guiding method for a guiding process of an aircraft.

### BACKGROUND OF THE INVENTION

1. Field of the Invention

The present disclosure relates to a monitoring system for an aircraft guiding process; in particular, to a monitoring system capable of cooperating with an advanced visual docking guidance system (AVDGS) at an apron of an airport.

2. Description of Related Art

A visual docking guidance system (VDGS) is an electronic device installed on top of the gate of an apron. The VDGS detects the position of an aircraft and provides guiding status with visual signals to indicate to a pilot a designated position to dock an aircraft. Currently, the VDGS has evolved to a more advanced version, the advanced visual docking guidance system (AVDGS), which is capable of precisely locating an aircraft's position, and usually a large-size guiding display is provided at the docking position. When the aircraft enters into a guiding range, the guidance system displays the preset aircraft model on the guiding display for the pilot. If the pilot notices that the aircraft model does not match with that of the aircraft, the ground crew can be informed immediately to prevent accidents caused by mis-docking. During the guidance process, information such as the direction of the aircraft and the distance between stop lines is shown on the guiding display for the pilot so that he can pilot the aircraft to the right docking position accordingly. Even a slight error during the aircraft docking process and the guiding process of the guidance system could result in huge damage and lost.

Thus, airports usually are built with a central management and control unit for in-time monitoring of the status of each apron and the docking situation of the aircrafts. However, there is still room for improvement in the art with respect to management, monitoring and maintenance.

### SUMMARY OF THE INVENTION

The object of the present disclosure is to provide a monitoring system for an aircraft guiding process; the monitoring system provides more convenient, in-time and intuitive monitoring on aircraft docking status at each apron. A guiding display is used for in-field comparison to achieve convenient management, in-time monitoring, remote maintenance and records retrieval, and further to lower management loading and maintenance manpower.

The present disclosure provides a monitoring system for an aircraft guiding process and for monitoring a docking process of an aircraft guided by a guiding information display of a VDGS (Visual Docking Guidance System) along a J-line at an apron, the monitoring system includes at least one image capturing module and each including a first camera for filming the docking process of the aircraft to obtain a docking video, and a second camera for filming the screen of the guiding information display to obtain a guiding information video; an image integrating unit, configured to integrate the docking video and the guiding information video into an integrated video in a synchronously-displayed and adjoining manner; a monitoring display, configured to receive and to display the integrated video; and a video recorder, configured to record the integrated video.

The present disclosure provides a monitoring method for aircraft guiding process and for monitoring a docking process of an aircraft guided by a guiding information display of a VDGS (Visual Docking Guidance System) along a J-line at an apron, the method includes: filming a docking video of the aircraft during the docking process; filming a guiding information video of the guiding information display during guiding process; integrating the docking video and the guiding information video into an integrated video in a synchronously-displayed and adjoining manner; transmitting the integrated video to a monitoring display; and recording the integrated video.

In order to further the understanding regarding the present disclosure, the following embodiments are provided along with illustrations to facilitate the disclosure of the present disclosure.

### BRIEF DESCRIPTION OF THE DRAWINGS

FIG. 1 shows a diagram of a monitoring system for an aircraft guiding process according to the present disclosure;

FIG. 2 shows a diagram of filming a process of an aircraft being guided to dock along a J-line according to the present disclosure;

FIG. 3 shows a diagram of an integrated video;

FIG. 4 shows a diagram of a monitoring system for an aircraft guiding process applied at multiple aprons in an airport;

FIG. 5 shows a diagram of a monitoring system for an aircraft guiding process corresponding to multiple integrated videos of multiple aircrafts; and

FIG. 6 shows a diagram of a monitoring system for an aircraft guiding process displaying all the aprons of an airport on a monitoring display.

### DETAILED DESCRIPTION OF THE PREFERRED EMBODIMENTS

The aforementioned illustrations and following detailed descriptions are exemplary for the purpose of further explaining the scope of the present disclosure. Other objectives and advantages related to the present disclosure will be illustrated in the subsequent descriptions and appended drawings.

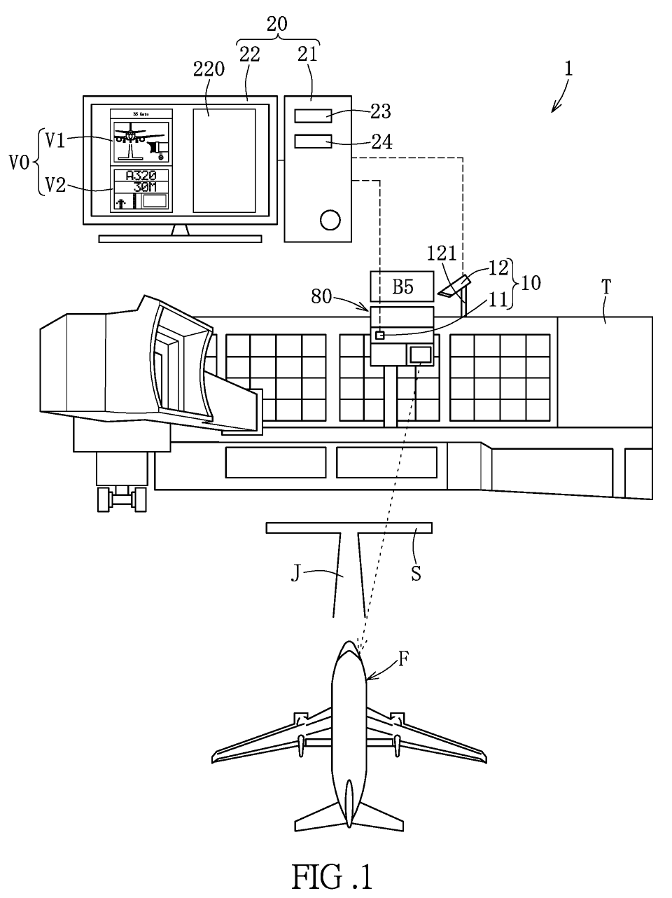

Referring to FIG. 1, the present disclosure provides a monitoring system 1 for an aircraft guiding process, and for monitoring a docking process of an aircraft F guided by a guiding information display 80 of a VDGS (Visual Docking Guidance System) along a J-line J at an apron. The monitoring system for an aircraft guiding process of the present disclosure may be applied at a single apron of a small-size airport, or at multiple aprons of a large-size airport. The VDGS, in addition to the guiding information display 80, also includes a laser scanning device and a computer, in which the laser scanning device is for emitting laser beams used for detection and distant measurement. Relevant details thereof may be referred to in U.S. Pat. No. 9,177,483 B2, “Guiding method for aircraft docking process,” and U.S. Pat. No. 9,459,119 B2, “Aircraft guidance system having reviewing and video synchronization abilities, and reviewing and video synchronization device of the same” under the same applicant.

Taking one single apron as an example, the monitoring system 1 for an aircraft guiding process includes an image capturing module 10, an image integrating unit 23, a monitoring display 22 and a video recorder 24. Each image capturing module 10 includes a first camera 11 for filming the docking process of the aircraft F to obtain a docking video V1, and a second camera 12 for filming the screen of the guiding information display 80 to obtain a guiding information video V2. The image integrating unit 23 integrates the docking video V1 and the guiding information video V2 into an integrated video V0 in a synchronously-displayed and adjoining manner. The video recorder 24 records the integrated video V0.

In the present embodiment, the first camera 11 may be built in the guiding information display 80, or be at a position close to the guiding information display 80. The second camera 12 may be installed at the front of the guiding information display 80, e.g., it may be fixed on the outer frame of the guiding information display 80 by a frame 121, or may be installed at a terminal T of an airport.

In the present embodiment, the image integrating unit 23, the monitoring display 22 and the video recorder 24 may be integrated in a monitoring computer 20. The monitoring computer 20 may include the monitoring display 22 and a mainframe 21. To be more specific, the image integrating unit 23 may be achieved by loading relevant software into the mainframe 21, and the software may be, but not limited to, installed in a hard disk or a chip. The video recorder 24 may be, but not limited to, a hard disk or a portable memory device. However, the present disclosure is not limited to the above instances; for example, the video recorder may be other devices capable of recording and be separate from the monitoring computer, such as a portable recorder.

After the VDGS detects the aircraft F, the VDGS gives a triggering signal to start guidance, and the first and second cameras 11, 12 are triggered to start recording. The video recorder 24 is activated to record the integrated video V0 after the monitoring computer 20 receives the triggering signal.

After the VDGS completes guiding the aircraft F, the VDGS transmits an ending signal for finishing the guidance to the monitoring computer 20, and after the monitoring computer 20 receives the ending signal, the video recorder 24 ends the recording of the integrated video V0.

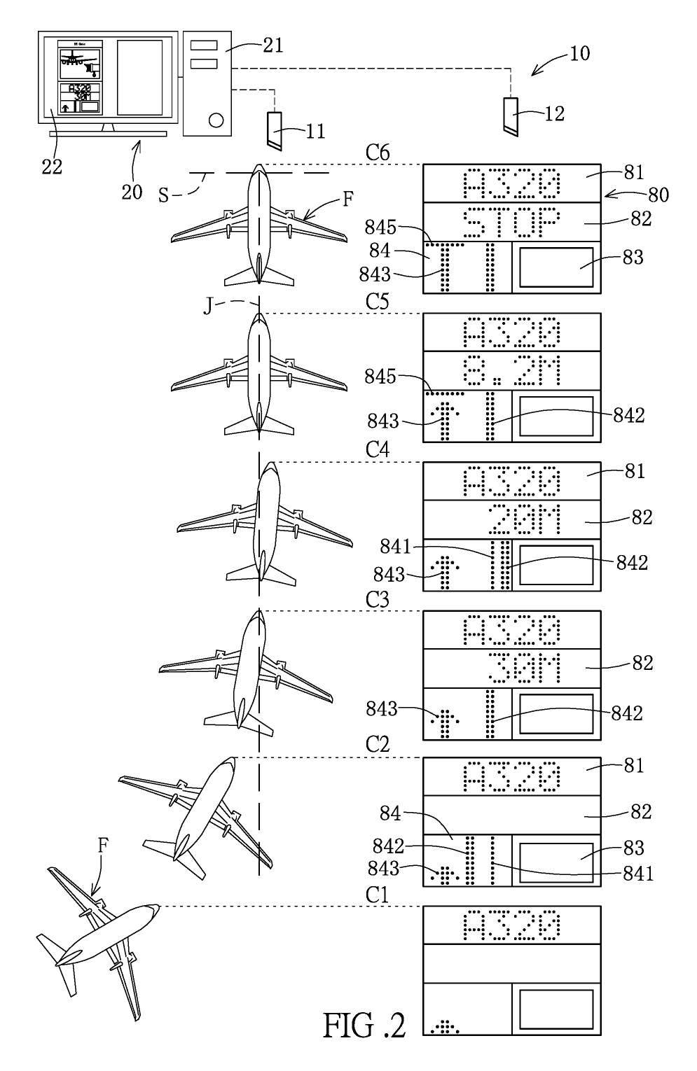

Reference is made to FIG. 2, which illustrates the docking process of the aircraft F filmed by the image capturing module 10, and each screen of the guiding information display 80. To the left side of FIG. 2, a top view of the aircraft F sliding from the runway to the apron is shown. The first camera 11 of the image capturing module 10 is used to film the docking process of the aircraft F from the front (different from the top view of FIG. 2) to provide the aforementioned docking video V1. To the right side of FIG. 2, a guiding screen of the guiding information display 80 in different situations is shown. In situation C1, the aircraft F gradually draws near the J-line J and, in situations C2 to C6, the aircraft F moves along the J-line J until arriving at the stop line S. The second camera 12 of the image capturing module 10 is used in the present disclosure to film the aforementioned guiding screens of the guiding information display 80 to provide the guiding information video V2.

Before the aircraft F reaches the J-line, the ground crew may determine and enter the aircraft model into the system, such as A320, and it would be displayed on a model column 81 of the guiding information display 80. Alternatively, the appearance features of the aircraft F may be obtained by a laser scanner 83 of the VDGS, a computer may determine whether the entered model is correct and transmit a relevant message for the ground crew's reference, so that the correct model can be transmitted to the model column 81 of the guiding information display 80.

Reference is made with FIG. 2. Under situation C1, the laser scanner 83 starts to scan the aircraft F and then the VDGS is activated. After being confirmed by the ground crew, the scanning result is then transmitted to the model column 81 of the guiding information display 80 to display the model of the aircraft F for the pilot's reference. If the displayed model of the aircraft F is incorrect, the aircraft F should stop and confirm with the ground crew or other control members until an appropriate docking procedure for the correct model is secured to avoid mis-docking accidents.

In situation C2, the guiding information display 80 further shows that the aircraft F is biased to the left. The single dotted line 841 in a left bottom display area 84 represents the J-line J, the double dotted line 842 represents the location of the aircraft F relative to the J-line J, and the dotted arrow 843 represents the indication to move on, so as to indicate to the pilot that the aircraft F is biased to the left so that he is able to direct the aircraft F to the right and keep moving on.

In situation C3, the guiding information display 80 further shows in a middle display area 82 that the distance between the aircraft F and the stop line S is 30 meters, which means that the aircraft F has entered into the guiding area. Only a double dotted line is shown in the left bottom display area 84, representing that the aircraft F is already on the J-line J. The dotted arrow 843 represents the indication to move on. The pilot continues piloting the aircraft to move forward.

In situation C4, the guiding information display 80 further shows in the middle display area 82 that the distance between the aircraft F and the stop line S is 20 meters, and in the left bottom display area 84, the double dotted line 842 is at the right side of the single dotted line 841, which reminds the pilot that the aircraft F is biased to the right and should be directed to the left. The dotted arrow 843 represents the instruction to move on. The pilot continues piloting the aircraft to move forward.

In situation C5, the guiding information display 80 shows in the middle display area 82 that the distance between the aircraft F and the stop line S is 8.2 meters. In the left bottom display area 84, only the double dotted line 842 is shown, which means that the route of the aircraft F is modified to be back on the J-line J. In the left bottom display area 84, a dotted horizontal line 845 is shown on top of the dotted arrow 843, which represents the stop line S. The pilot slows down the speed of the aircraft F when nearing the stop line S to slowly approach the stop line S.

In situation C6, a “STOP” word is displayed in the middle display area 82 of the guiding information display 80, indicating that the aircraft F has arrived at the stop line S and that the pilot should stop the aircraft F immediately, and the left bottom display area 84 shows a T shape, which represents “stop piloting.”

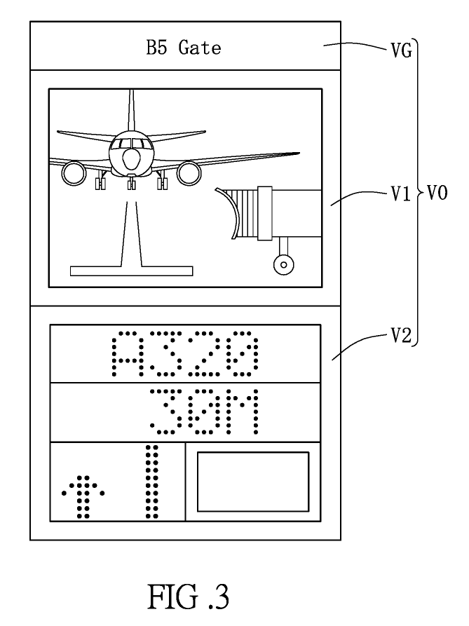

Reference is made to FIG. 3, where FIG. 3 shows a diagram of an integrated video. In the present embodiment, by a preferable manner of stacking, the docking video V1 and the guiding information video V2 are synchronously shown, which allows them to form an adjoining integrated video V0. The integrated video V0 preferably shows the number of the gate VG as well, such as “B5 Gate.” The first camera 11 and the second camera 12 at the apron can simultaneously and collectively display, record and playback by utilizing software, allowing users to synchronously be aware of the contents of the in-time video of the aircraft and that displayed on the guiding information display 80.

For the recording process of the present disclosure, the video recorder 24 may use the VDGS to provide a trigger function. When the aircraft enters into the guiding process, the first camera 11 and the second camera 12 are triggered to record, and the video recorder 24 is activated to store the integrated video V0. Moreover, as in situation C6 shown in FIG. 2, after the VDGS completes guidance of the aircraft F, an ending signal would be transmitted to the monitoring computer 20, and the video recorder 24 ends the storing of the integrated video V0 after the monitoring computer 20 receives the ending signal.

The monitoring computer 20 of the present disclosure preferably takes each docking of an aircraft F as one event, and accordingly stores the integrated videos V0 as video files. The file name of the video files should preferably include the recording time and the number of the apron, e.g., 20150101_0502_B5.mpg. The guidance videos can easily be retrieved based on the recording time and number of apron in the file names, thus facilitating the inspection of potential mis-guidances. Moreover, the videos can be synchronously played in pilot training. Furthermore, the video files may be used to showcase the VDGS via the Internet.

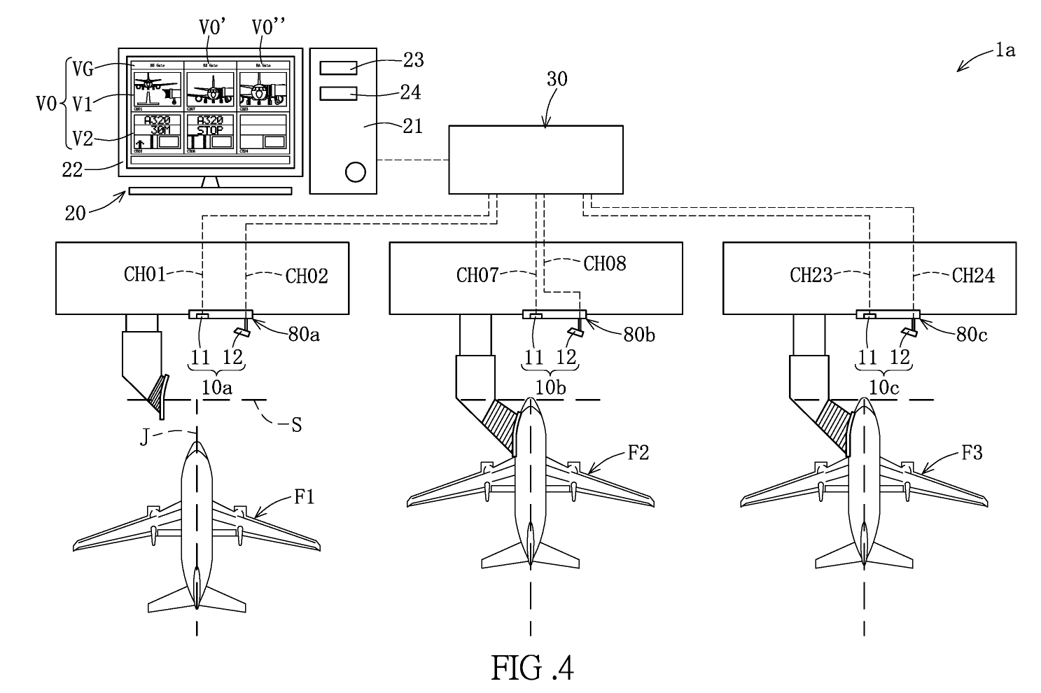

Reference is made to FIG. 4. The monitoring system for an aircraft guiding process of the present disclosure may be applied to multiple aprons of an airport. The monitoring system 1a for an aircraft guiding process may include multiple image capturing modules 10, and an image switching device 30. The multiple image capturing modules 10 correspond to multiple aircrafts F1, F2, F3 and multiple guiding information displays 80. The multiple image capturing modules 10 connect with the image switching device 30, and the image switching device 30 electrically connects with the image integration unit 23, so as to form multiple integrated videos V0.

For the image capturing module 10a on the left side of FIG. 4, by filming the docking process of the aircraft F1 to obtain a docking video V1 by the first camera 11, the docking video V1 is transmitted to the mainframe 21 of the monitoring computer 20 by the channel CH01 and by the switching device 30. The screen of the guiding information display 80a is filmed by the second camera 12 and a guiding information video V2 is then obtained, and the guiding information video V2 is transmitted to the mainframe 21 of the monitoring computer 20 by the channel CH02 and by the switching device 30.

For the image capturing module 10b in the middle of FIG. 4, a docking video V1 is filmed by the first camera 11, and the docking video V1 is transmitted to the mainframe 20 of the monitoring computer 20 by the channel CH07 and by the switching device 30. The screen of the guiding information display 80b is filmed by the second camera 12 and a guiding information video V2 is then obtained, and the guiding information video V2 is transmitted to the mainframe 21 of the monitoring computer 20 by the channel CH08 and by the switching device 30.

For the image capturing module 10c at the right side of FIG. 4, a docking video V1 is filmed by the first camera 11, and the docking video V1 is transmitted to the mainframe 20 of the monitoring computer 20 by the channel CH23 and by the switching device 30. The screen of the guiding information display 80c is filmed by the second camera 12 and a guiding information video V2 is then obtained, and the guiding information video V2 is transmitted to the mainframe 21 of the monitoring computer 20 by the channel CH24 and by the switching device 30.

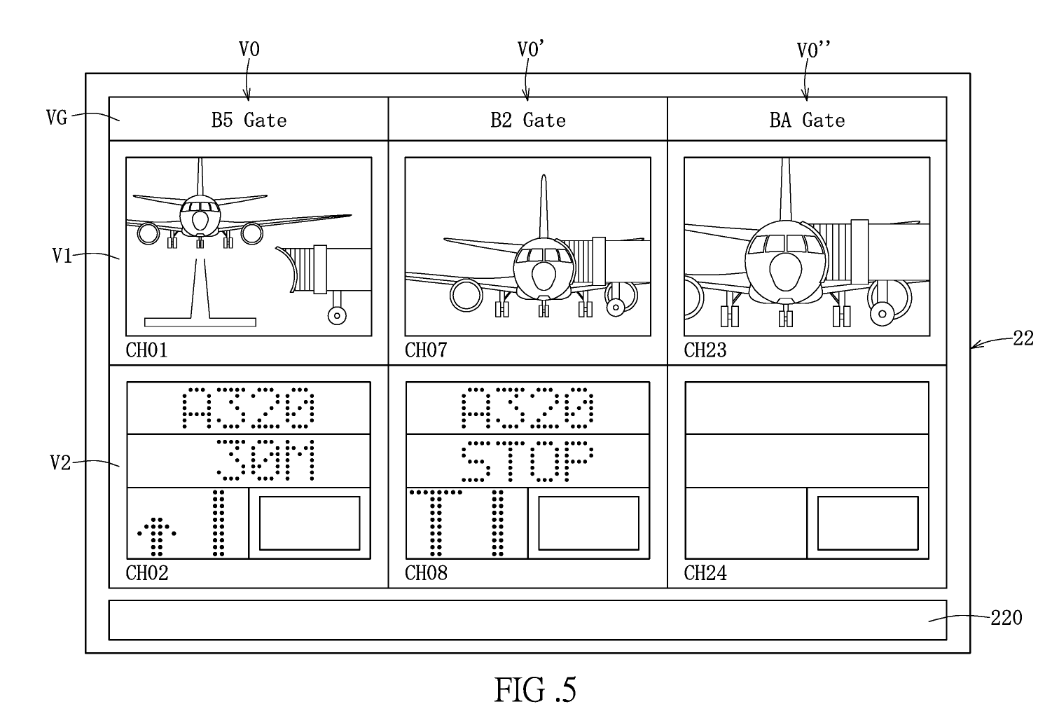

As shown in FIG. 5, information regarding the corresponding gate number of each of the aforementioned channels may be saved in the monitoring computer 20. The two videos transmitted from each predetermined pair of adjoining channels, e.g., channels CH01 and CH02, channels CH07 and CH08, and channels CH23 and CH24, can respectively be integrated into integrated videos V0, V0′, and V0″ by software. The above-mentioned three integrated videos V0, V0′ and V0″ are displayed on the same monitoring screen 22 in parallel, but the number of parallel displays should not be limited to that disclosed in the present embodiment. For example, more integrated videos could be displayed in parallel if the width of the monitoring screen 22 is wider.

The guiding information video V2 at the bottom of the integrated video V0″ in FIG. 4 appears to be blank, which means that the ending signal has been received and the recording has stopped. If the monitoring computer 20 receives a new triggering signal, which means the VDGS has detected that another aircraft F is about to dock, the monitoring computer 20 may remove the completed integrated video from the monitoring screen 22, such as the integrated video V0″, and transmit an integrated video corresponding to the new triggering signal to the monitoring screen 22.

According to the monitoring system for aircraft guiding process of the present disclosure, the monitoring system further provides a control interface 220 electrically connected with the guiding information display for the monitoring staff to give an indication signal, such as a “STOP” word for emergency stops to be displayed on the guiding information display to guide the aircraft. The control interface 220 may be designed to have multiple buttons, such as a stop button, etc.

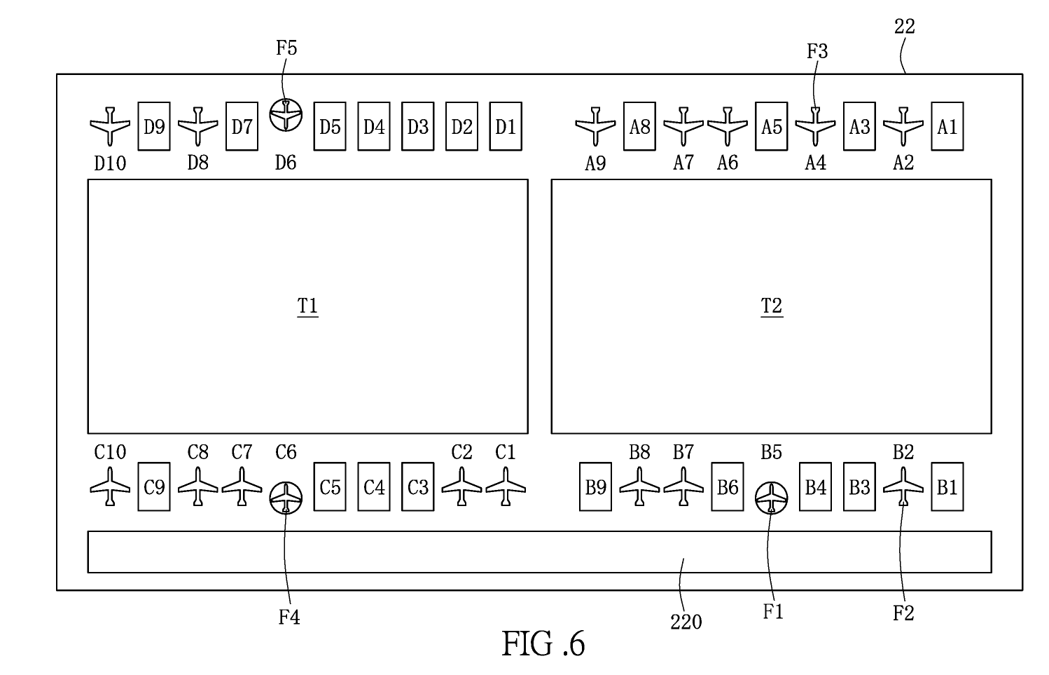

As shown in FIG. 6, according to the monitoring system for an aircraft guiding process of the present disclosure, a diagram showing all aprons of an airport can be provided through the monitoring screen 22. The diagram may be switched by the control interface 220, so as to be displayed on the monitoring screen 22. Multiple aprons are at each side of Terminals T1 and T2, and are each represented by an alphabet and a digit, a square box representing that no aircraft is docked thereon, an aircraft shape represents that an aircraft is docked thereon, and an aircraft shape with a circle represents that the aircrafts F1, F4 and F5 are under docking process.

According to the monitoring system for an aircraft guiding process, a monitoring method for an aircraft guiding process and for monitoring a docking process of an aircraft guided by a guiding information display of a VDGS (Visual Docking Guidance System) along a J-line at an apron is also provided. The monitoring system includes the following steps (with FIG. 1 referred together): Step S11, filming a docking video V1 of the aircraft F during a docking process; Step S12, filming a guiding information video V2 of the guiding information display 80 during a guiding process; Step S13, integrating the docking video V1 and the guiding information video V2 into an integrated video V0 in a synchronously-displayed and adjoining manner; Step S14, transmitting the integrated video V0 to a monitoring display; and Step S15, recording the integrated video V0.

Moreover, the monitoring method for aircraft guiding process of the present disclosure further includes a step of transmitting a triggering signal for starting a guidance after the VDGS detects an aircraft F, in order to start a storing of the integrated video V0; and transmitting an ending signal for finishing the guidance after the VDGS completes guiding the aircraft F, in order to end the storing of the integrated video V0.

The step of recording the integrated video further includes: Step S151, based on recognizing each docking of an aircraft F as a single event, storing the integrated video V0 as a video file; and Step S152, storing the recording time and number of the apron in the file name of the integrated video V0.

Referring back to FIG. 4, the monitoring system 1a for aircraft guiding process includes multiple image capturing modules 10, and the present disclosure further includes the following steps: providing an image switching device 30 configured to receive the multiple docking videos V1 and the multiple guiding information videos V2; electrically connecting the image switching device 30 with the image integrating unit 23 to form the multiple integrated videos V0, V0′, V0″; removing the integrated video in which guidance has been completed according to a new triggering signal; and transmitting the integrated video corresponding to the new triggering signal to the monitoring display.

Furthermore, the present disclosure includes the following step: providing a control interface 220 electrically connected with the guiding information display, so that the monitoring staff can give an indication signal to be displayed on the guiding information display to guide the aircraft.

In sum, the features and functions of the monitoring system for an aircraft guiding process according to the present disclosure in management of the VDGS at each apron of an airport are that, by utilizing the specific arrangement of the image capturing module 10, and by the integration of the image integrating unit 23, functions such as convenient management, in-time monitoring, remote maintenance and recording retrieval and in-field display may be accomplished.

The present disclosure may be used in a control room for in-time monitoring of the status of each apron, and can even give an instant instruction therefrom such that manpower can be saved. For example, by giving a stopping instruction from a control room, the safety of in-field guidance may be enhanced. By connecting the monitoring computer 20 to the Internet, the guiding status of each apron may be checked at any time via the Internet, including aircraft piloting behavior and the functional status of the system.

According to the present disclosure, manpower in management and maintenance can be saved, and by connecting to the Internet, the effects of the VDGS can be instantly exhibited in detail.

The descriptions illustrated supra set forth simply the preferred embodiments of the present disclosure; however, the characteristics of the present disclosure are by no means restricted thereto. All changes, alterations, or modifications conveniently considered by those skilled in the art are deemed to be encompassed within the scope of the present disclosure delineated by the following claims.

What is claimed is:

1. A monitoring system for an aircraft guiding process and for monitoring a docking process of an aircraft guided by a guiding information display of a VDGS (Visual Docking Guidance System) along a J-line at an apron, comprising:
at least one image capturing module and each including:
a first camera for filming the docking process of the aircraft to obtain a docking video; and
a second camera for filming the screen of the guiding information display to obtain a guiding information video;
an image integrating unit, configured to integrate the docking video and the guiding information video into an integrated video in a synchronously-displayed and adjoining manner;
a monitoring display, configured to receive and to display the integrated video; and
a video recorder, configured to record the integrated video.

2. The monitoring system according to claim 1, wherein the first camera is installed in the guiding information display and the second camera is installed at the front of the guiding information display.

3. The monitoring system according to claim 1, wherein the image integrating unit, the monitoring display and the video recorder are integrated in a monitoring computer; wherein after the VDGS detects the aircraft, the VDGS gives a triggering signal for starting a guidance and the first and second cameras are triggered to start recording, and the video recorder is activated to record the integrated video after the monitoring computer receives the triggering signal.

4. The monitoring system according to claim 3, wherein after the VDGS completes guiding the aircraft, the VDGS transmits an ending signal for finishing the guidance to the monitoring computer, and after the monitoring computer receives the ending signal, the video recorder ends the recording of the integrated video; wherein the monitoring computer, recognizing each docking of an aircraft as one event, stores the integrated video as a video file, and the file name of the video file includes the recording time and the number of the apron.

5. The monitoring system according to claim 3, wherein the system includes multiple image capturing modules and an image switching device, the multiple image capturing modules correspond to multiple aircrafts and the multiple guiding information displays, the multiple image capturing modules connect with the image switching device, the image switching device electrically connects with the image integrating unit to form the multiple integrated images; wherein the monitoring computer removes the integrated video which has completed the guidance after receiving a new triggering signal, and transmits the integrated video corresponding to the new triggering signal to the monitoring display.

6. The monitoring system according to claim 1, wherein a controlling interface is further provided and is electrically connected with the guiding information display, and is for a monitoring staff to give an indicating signal to be displayed on the guiding information display to guide the aircraft.

7. A monitoring method for an aircraft guiding process and for monitoring a docking process of an aircraft guided by a guiding information display of a VDGS (Visual Docking Guidance System) along a J-line at an apron, comprising:
filming a docking video of the aircraft during a docking process;
filming a guiding information video of the guiding information display during a guiding process;
integrating the docking video and the guiding information video into an integrated video in a synchronously-displayed and adjoining manner;
transmitting the integrated video to a monitoring display; and
recording the integrated video.

8. The monitoring method according to claim 7, further comprising:
transmitting a triggering signal for starting a guidance after the VDGS detects an aircraft, in order to start a storing of the integrated video; and
transmitting an ending signal for finishing the guidance after the VDGS completes guiding the aircraft, in order to end the storing of the integrated video.

9. The monitoring method according to claim 8, wherein the step of recording the integrated video further includes:
based on recognizing each docking of an aircraft as one event, storing the integrated video as a video file; and
storing a recording time and a number of the apron in the file name of the integrated video.

10. The monitoring method according to claim 9, further comprising:
providing an image switching device configured to receive the multiple docking videos and the multiple guiding information videos;
electrically connecting the image switching device with the image integrating unit to form the multiple integrated videos;
removing the integrated video in which guidance has been completed according to a new triggering signal; and
transmitting the integrated video corresponding to the new triggering signal to the monitoring display.
